(19) United States
(12) Patent Application Publication
(10) Pub. No.: US 2008/0147706 A1
(43) Pub. Date: Jun. 19, 2008

(54) SUBSCRIBING TO ITEMS IN AN AGENDA

(76) Inventors: Debbie Ann Anglin, Austin, TX (US); Howard Neil Anglin, Austin, TX (US); Nyralin Novella Kline, Round Rock, TX (US)

Correspondence Address: IBM CORP (YA);C/O YEE & ASSOCIATES PC, P.O. BOX 802333, DALLAS, TX, 75380, US

(21) Appl. No.: 11/610,286

(22) Filed: Dec. 13, 2006

(51) Int. Cl. G06F 17/30; G06F 13/00; G06F 15/16

(52) U.S. Cl. 707/102; 710/305; 709/206; 707/E17.044

(57) ABSTRACT

A computer implemented method, apparatus, and computer program product subscribing to a set of items in an agenda. An agenda is created. The agenda comprises the set of items. A tag is associated with each item in the set of items to form a set of associated tags. A first user selects an associated tag from the set of associated tags, resulting in the first user subscribing to the item with the associated tag. Subscribing to the item means that the first user is sent an alert when an event related to the item occurs.

### BACKGROUND OF THE INVENTION

1. Field of the Invention

The present invention relates generally to data processing systems and in particular to electronic mail. Still more particularly, the present invention relates to a computer implemented method, apparatus, and computer program product for subscribing to items in an agenda.

2. Description of the Related Art

An employee in a corporation is often required to participate in meetings on a regular basis. Participating in meetings takes time away from other activities which the employee can perform. Therefore, it is advantageous to make meetings run as efficiently as possible. In order to run an efficient meeting, the meeting chairperson usually sends a detailed meeting agenda to all of the meeting participants. The meeting agenda contains a list of agenda items and details about each agenda item.

For example, an agenda item may provide details about the topic to be discussed, how much time has been allocated for the topic, and the name of the person who will be talking about the topic. Additional information related to the topic may also be provided, such as the action taken prior to the meeting and a proposal for actions to be performed after the meeting.

Often, an employee who is attending the meeting may only be interested in one or two specific agenda items. However, the employee must sit through the entire meeting in order to participate in the agenda items of interest to the employee. For example, an employee may have to sit through an hour long meeting although the employee is interested in only one ten minute topic, wasting fifty minutes of the employee's valuable time.

### SUMMARY OF THE INVENTION

The different embodiments provide a computer implemented method, apparatus, and computer program product subscribing to a set of items in an agenda. An agenda is created. The agenda comprises the set of items. A tag is associated with each item in the set of items to form a set of associated tags. A first user selects an associated tag from the set of associated tags, resulting in the first user subscribing to the item with the associated tag. Subscribing to the item means that the first user is sent an alert when an event related to the item occurs.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the illustrative embodiments may be implemented;

FIG. 2 is a block diagram of a data processing system in which the illustrative embodiments may be implemented;

FIG. 3 is a block diagram of software components in accordance with an illustrative embodiment;

FIG. 4 is a block diagram of an agenda in accordance with an illustrative embodiment;

FIG. 5 is a block diagram of an agenda in accordance with an illustrative embodiment;

FIG. 6 is a flowchart of a process for creating an agenda in accordance with an illustrative embodiment;

FIG. 7 is a flowchart of a process for receiving an agenda in accordance with an illustrative embodiment; and

FIG. 8 is a flowchart of a process for using an agenda in a meeting in accordance with an illustrative embodiment.

### DETAILED DESCRIPTION OF THE PREFERRED EMBODIMENT

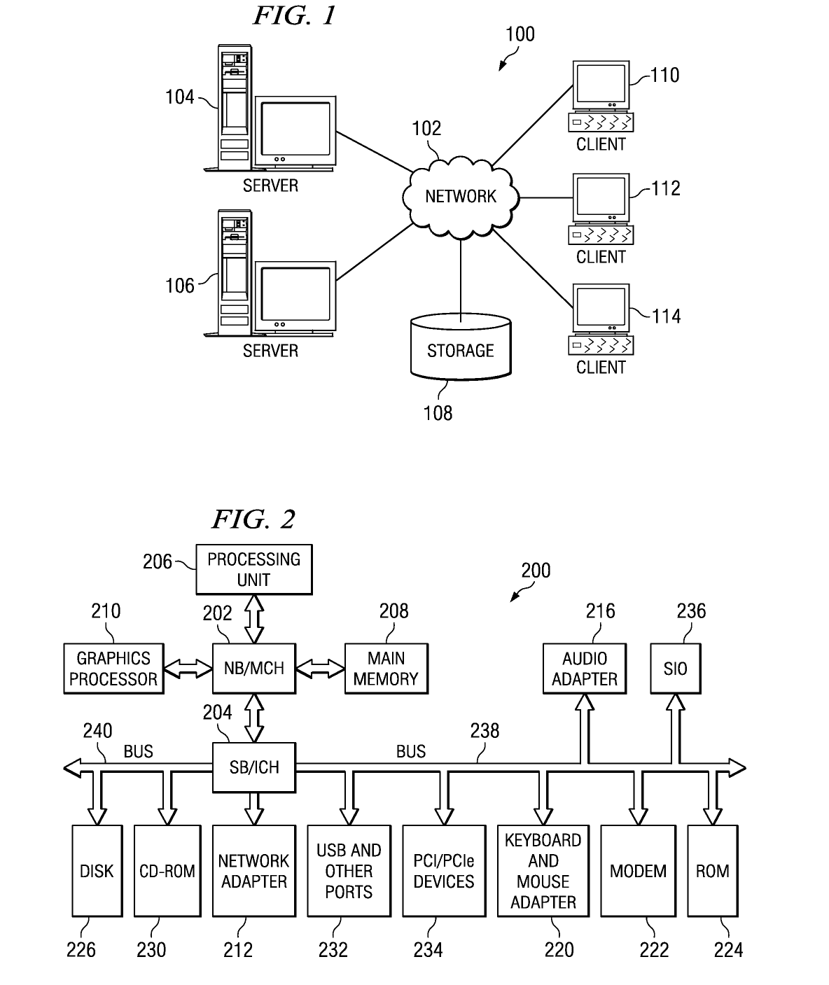

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Corporate employees regularly participate in meetings. Frequently, an employee may sit through an entire meeting in order to participate in one or two agenda items. The illustrative embodiments recognize that when a meeting agenda is sent out to meeting participants, it would be useful if each of the participants could subscribe only to the agenda items which are of interest to the participant.

The different illustrative embodiments provide a computer implemented method, apparatus, and computer program product subscribing to a set of items in an agenda. An agenda is created. The agenda comprises the set of items. A tag is associated with each item in the set of items to form a set of associated tags. A first user selects an associated tag from the set of associated tags, resulting in the first user subscribing to the item with the associated tag. Subscribing to the item means that the first user is sent an alert when an event related to the item occurs.

In the example given below, the agenda is shown being sent in an email. Those versed in the art will appreciate that the agenda may be sent in many different ways, such as a calendar item in a scheduling program.

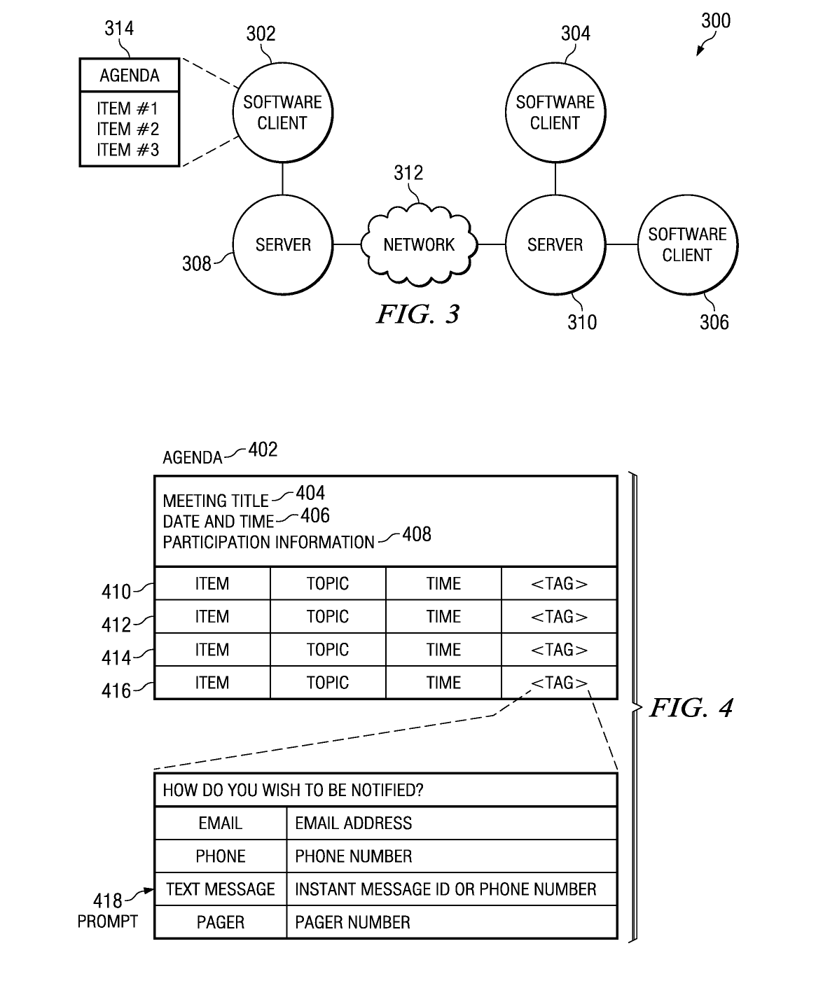

Referring to FIG. 3, a block diagram of software components is shown in accordance with an illustrative embodiment. Software components 300 illustrates the components used to send and receive agendas. Software clients 302, 304, and 306 are used to create, send, and receive agendas. Software clients 302, 304, and 306 may, for example, be software for creating calendar items or emails.

Servers 308 and 310 route messages over network 312. Servers 308 and 310 may, for example, be email or calendar event servers. Network 312 may be a local area network (LAN), wide area network (WAN), a combination of the two, or the internet. In this example, software client 302 is served by server 308, and software clients 304 and 306 are served by server 310.

Those versed in the art will appreciate that the communication regarding the agenda and the agenda item subscriptions may be communicated using a variety of methods, including electronic mail, instant messaging, or text messaging. Network 312 may be any network that uses one or more transmission technologies, such as wireline, wireless, or optical transmission. For example, network 312 may be the internet or a telecommunications network.

A chairperson may use software client 302 to create agenda 314. Agenda 314 may be an agenda for a meeting and may contain several agenda items. Once the chairperson has created agenda 314, the chairperson may send it to different users, such as the users of software clients 304 and 306.

Agenda 314 is composed and sent using software client 302. Agenda 314 is in initially sent to server 308. In this example, software clients 304 and 306 are served by server 310. Therefore, server 308 routes agenda 314 to server 310. Server 310 then routes the agenda to software clients 304 and 306.

The users of software clients 304 and 306 use software clients 304 and 306 to receive, read, and subscribe to specific agenda items in agenda 314. When users of software clients 304 and 306 subscribe to agenda items in agenda 314, the information regarding which agenda items the users subscribed is sent to server 310. Server 310 then routes the information to server 308, which sends the information to software client 302 so that the chairperson can see how many people have subscribed to each agenda item.

During the meeting, when an agenda item becomes the current item under discussion, the chairperson selects the agenda item in agenda 314. When the chairperson selects an agenda item in agenda 314, software client 302 sends a notification message to all subscribers of that agenda item. For example, if the user of software client 304 subscribed to an agenda item in agenda 314 and that agenda item is now under discussion, when the chairperson selects that agenda item, the user of software client 304 is notified.

Referring to FIG. 4, an agenda is shown in accordance with an illustrative embodiment. Agenda 402 is an example of an agenda a chairperson of a meeting may create and send using a client, such as software client 302 in FIG. 3. Agenda 402 contains contains meeting title 404, which describes the nature of the meeting. Agenda 402 may be an agenda, such as agenda 314 in FIG. 3. Date and time 406 provides information about the date and time at which the meeting is scheduled to start.

Participation information 408 contains information about how recipients of agenda 402 may participate in the meeting. Generally, participation information 408 will contain the physical location of the meeting, such as the city, street address, floor number, and room number where the meeting will be conducted. Participation information 408 may contain a telephone number and password, allowing participants to call in to a teleconferencing system and thereby participate in the meeting by telephone. Participation information 408 may also contain an Internet web address and password to allow participation in the meeting via Internet-based audio and/or video conferencing.

Items 410, 412, 414, and 416 represent a set of items on an agenda. In the examples given below, a set means one or more items. Of course, the agenda items shown in this example are purely for the purpose of illustration and it should be understood that an agenda may have a different set of agenda items.

Each agenda item has a topic. Each topic is a subject for discussion during the meeting, such as, introductory remarks, approve minutes of previous meeting, specific topics to be discussed such as new proposals, and closing remarks.

Each topic has an associated time. The time associated with a topic represents the amount of time the chairperson has allocated for discussing that particular topic. The time may be specified in terms of relative or absolute time. Relative time means that a specific length of time is specified, such as ten minutes or fifteen minutes. Absolute time means that a start time and an end time is specified, such as from 1:00 to 1:10 p.m. central standard time. Generally, the time is specified using relative terms because if the start time is changed, the relative terms remain valid whereas absolute terms must be re-calculated.

The embodiments provide a specific tag for each agenda topic. The tag allows a recipient of agenda 402, such as a user of software client 304 in FIG. 3, to subscribe to specific items in the agenda. Subscribe means that the recipient is notified immediately prior to when that specific agenda item will be discussed during the meeting. Once a recipient has subscribed to an agenda item, the recipient may also later unsubscribe.

Each tag is embedded in the agenda and visually indicates how the recipient may subscribe to each agenda item. For example, the tag may appear as a button with the words “click here to subscribe to this agenda item” on the button. Not all agenda items may have tags. The chairperson determines which agenda items may be subscribed to and then the chairperson creates tags only for those agenda items.

Once a recipient has subscribed to one or more agenda items, the agenda visually indicates which agenda items have been subscribed to by the recipient. For example, the agenda item may change shape, font, or color in response to the recipient subscribing to the agenda item. When the subscriber holds the computer cursor over the agenda item, the notification information may be displayed. The client, such as software client 304 or 306 in FIG. 3 may visually indicate which agenda items the recipient subscribed to in the agenda.

Agenda items which have been subscribed to may also display information about how the agenda recipient may unsubscribe. For example, those agenda items which have been subscribed to may display a message when the cursor is held over the agenda item, such as “You are currently subscribed to this agenda item. To unsubscribe, click here”.

A recipient of agenda 402 may therefore select the tags corresponding to the topics which the user is interested in order to subscribe to those topics. For example if the recipient is only interested in agenda item 414, then the recipient selects the tag corresponding to item 414. Similarly, if the recipient is interested in items 410 and 416, then the recipient selects the tags corresponding to items 410 and 416, respectively.

When a recipient selects a tag corresponding to an agenda item in agenda 402, the tag allows the recipient to subscribe to that agenda item. Once the recipient has subscribed, the same tag allows the user to unsubscribe from that agenda item. When a recipient subscribes to an agenda item, the recipient becomes a subscriber of that agenda item. When a recipient subscribes to an agenda item, the subscriber is prompted to specify in prompt 418 how the subscriber wishes to be notified when the agenda item is about to be discussed during the meeting.

Those versed in the art will appreciate that a subscriber to an agenda item may be notified in many different ways when the agenda item is about to be discussed, such as electronic mail (email), phone, text message, or pager. The methods discussed in this example are purely for the purpose of illustration and are not meant to be an exhaustive list of all possible notification methods. Those versed in the art will also appreciate that a subscriber to an agenda item may be prompted in many different ways on how the subscriber wishes to be notified and that the example provided is purely for illustration purposes.

For example, a recipient may be interested in and subscribe to item 412 by selecting the tag corresponding to item 412. After selecting the tag, a prompt, such as prompt 418, is shown to the subscriber. If the subscriber wishes to be notified by telephone, then the subscriber types in a telephone number next to the phone field in prompt 418.

When the chairperson is conducting the meeting, the chairperson selects an agenda item to indicate that the agenda item is under discussion. When the chairperson selects an agenda item, all participants subscribing to that agenda item are notified. Once the subscribers to the agenda item are notified, those subscribers can participate in the meeting by taking appropriate action. For example, a subscriber can, after being notified, walk to the meeting room, call the teleconference number, or log on to the Internet to join the meeting.

It may take several minutes for each subscriber to be notified and a few more minutes for the subscriber to take appropriate action to participate in the meeting. The delay between when a notification is sent to a subscriber and when the subscriber can begin to participate in the meeting may be handled in many different ways. For example, the chairperson may select the agenda item a few minutes prior to the agenda item coming under discussion. Alternately, the chairperson may schedule a short break before heavily subscribed agenda items in order to allow participants to be notified and take appropriate action.

A third way in which subscribers may be notified is to notify subscribers when the chairperson selects the agenda item prior to the subscribed agenda item. For example, when the chairperson selects the tag for item 410 to indicate that the discussion for item 410 is about to begin, all subscribers to the next agenda item, item 412, may be notified. By notifying subscribers to item 412 when item 410 is under discussion, the subscribers are given time to receive notification and take appropriate action to participate in the meeting.

By selecting the agenda item a few minutes prior to that agenda item being discussed, the chairperson may provide subscribers enough time to perform the actions needed to participate in the meeting. As previously mentioned, once a subscriber is notified that an agenda item is currently under discussion in the meeting, the subscriber should take appropriate actions to join the meeting, such as dialing the telephone conferencing number.

When a chairperson selects an agenda item, each person who has subscribed to that agenda item is notified. Each subscriber is notified using the subscription method the subscriber specified in prompt 418. For example, if a subscriber specified an email address in prompt 418, then the subscriber receives an email at the email address when the chairperson selects the agenda item.

The chairperson may optionally be notified as to how many people have subscribed to each agenda item. The chairperson may optionally be provided detailed information about each subscriber, such as the name and notification method for each subscriber. By providing the chairperson with information on subscribers to each agenda item, the chairperson can determine how to handle agenda items with many subscribers. For example, the chairperson may decide to take a break or select an agenda item a little early for agenda items which have many subscribers.

Sometimes, an agenda item may not be completely resolved in one meeting and the agenda item may therefore carry over to a follow-up meeting. When the agenda recipient initially subscribes to the agenda item, the agenda recipient may optionally be asked whether the subscriber wishes to subscribe to any follow-up meetings. With this option, the subscriber stays subscribed to the agenda item for all subsequent meetings containing that agenda item until the agenda item is resolved.

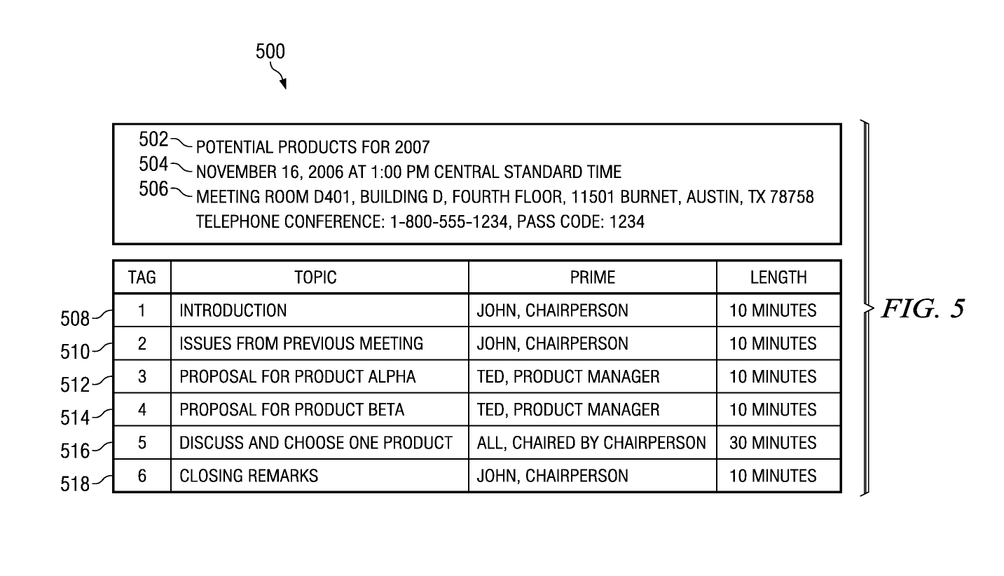

Referring to FIG. 5, a diagram of an agenda is depicted in accordance with an illustrative embodiment. The title of agenda 500 is title 502, “Potential Products for 2007”. Date and time 504 indicate that the meeting is scheduled for Nov. 16, 2006 at 1:00 p.m. central standard time. Participation info 506 contains the physical address of the meeting for those wishing to attend in person and a phone number and passcode for those participating by teleconference.

Items 508-518 are seven agenda items on the agenda. The first item on the agenda, item 508, is the introduction. The first item is scheduled for ten minutes of discussion and is primed by the chairperson. The second item, item 510, is a discussion of issues from the previous meeting, is scheduled for ten minutes, and is primed by the chairperson. The third item, item 512 is a proposal for product Alpha by product manager Ted for ten minutes. The fourth item, item 514, is a proposal for product Beta by product manager John for ten minutes.

The fifth item, item 516, is a discussion about choosing a product for next year based on the two previous proposals for thirty minutes by all of the participants. Finally, the sixth item on the agenda, item 518, is the closing remarks of the chairperson for ten minutes.

As the meeting progresses, the chairperson selects a tag to indicate that the discussion for that agenda item is about to begin. The chairperson may use a client, such as software client 302 in FIG. 3 to select the tag associated with an agenda item to indicate that the agenda item is under discussion. For example, the chairperson may select the tag corresponding to item 508 prior to starting the introductions for the meeting. Once the introductions are completed, the chairperson selects the tag corresponding to the second agenda item, item 510, and begins discussion of issues from the previous meeting. In this way, for each agenda item in the agenda, the chairperson selects the tag for an agenda item when the agenda item becomes the current topic of discussion.

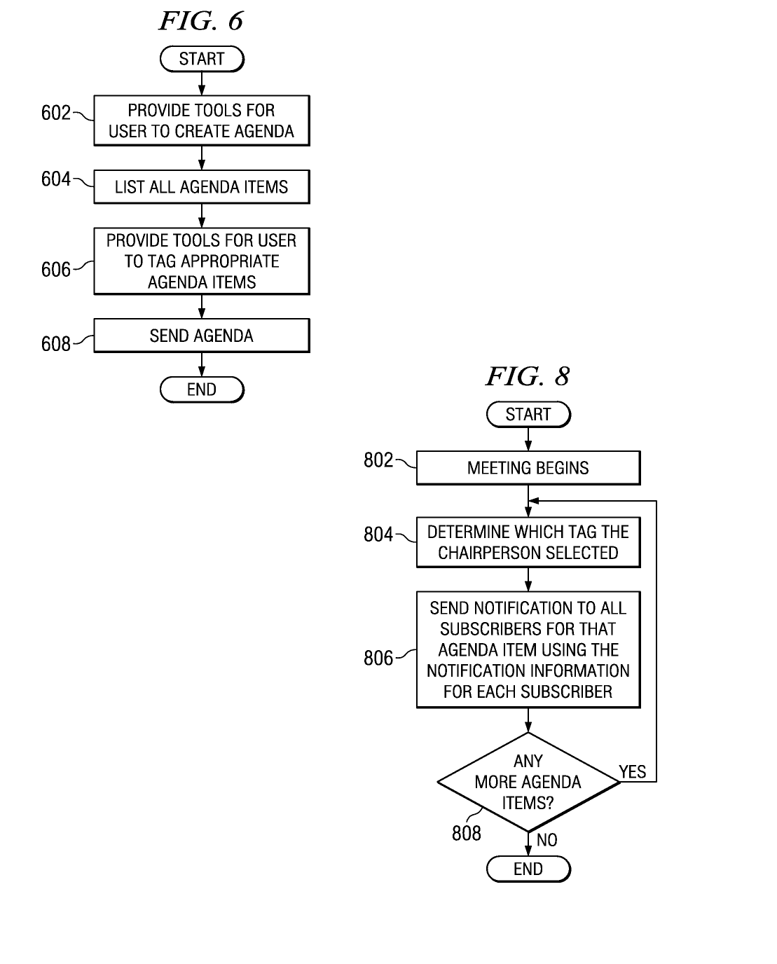

FIG. 6 is a flowchart of a process for creating an agenda in accordance with an illustrative embodiment. A software process, such as software client 302 in FIG. 3, executes the flowchart shown in FIG. 6.

The process begins when a user, such as the meeting chairperson, uses the software to create an agenda (step 602). The chairperson uses the software to list all the agenda items for the meeting (step 604). The chairperson determines which agenda items to tag and then uses the software to tag the appropriate agenda items (step 606). The chairperson then uses the software to send the agenda (step 608) and the process ends.

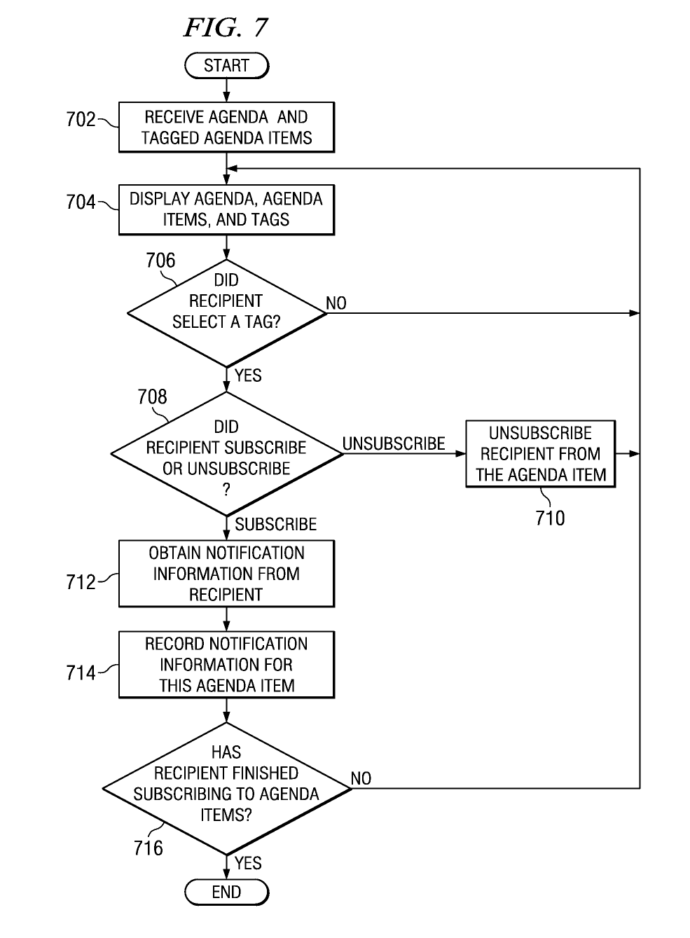

FIG. 7 is a flowchart of a process for receiving an agenda in accordance with an illustrative embodiment. A software process, such as software client 304, in FIG. 3, executes the flowchart shown in FIG. 7. The process begins when a recipient receives an agenda with tagged agenda items (step 702). The software displays the agenda, agenda items, and tags (step 704). Each tag indicates to the recipient that the tag may be used to subscribe to the agenda item associated with the tag. For example, the tag may have a button labeled “Click here to subscribe to this agenda item.”

Next, a determination is made as to whether the recipient of the message selected a tag (step 706). If the answer is “no” and the recipient did not select a tag, then the software returns to step 704 and displays the agenda, agenda items, and tags.

If the answer is “yes” and the recipient selected a tag, then a determination is made as to whether the recipient subscribed or unsubscribed to an agenda item (step 708). If the recipient unsubscribed to the agenda item, then the recipient is unsubscribed from receiving a notification regarding the agenda item (step 710) and the process returns to displaying the agenda, agenda items, and tags in step 704.

If a determination is made in step 708 that the recipient subscribed to the agenda item, then the recipient is asked to provide notification information (step 712). The notification information includes the means for contacting the subscriber, such as email, instant messaging, pager alert, automated voice message, or text message. The notification information also includes information about the means, such as an email address, instant message identifier, pager number, or phone number.

The notification information may optionally indicate whether the subscriber wishes to remain subscribed to the agenda item until the agenda item is resolved. Suppose the subscriber indicates that the subscriber wishes to remain subscribed to the agenda item until the agenda item is resolved. If the agenda item is not resolved in the upcoming meeting, the agenda item is carried over to a subsequent meeting, and the subscriber remains subscribed to the agenda item in the subsequent meeting without the subscriber having to take any further action.

Next, the software records the notification information and associates the notification information with the agenda item corresponding to the tag (step 714). A determination is made as to whether the recipient has finished subscribing to the agenda items (step 716). If the answer is “no”, then the software returns to step 704 and displays the agenda, agenda items, and tags. If the answer is “yes”, and the recipient has finished subscribing to the agenda items of interest to the recipient, then the process ends.

FIG. 8 is a flowchart of a process for using an agenda in a meeting in accordance with an illustrative embodiment. A software process running on the computer of a chairperson, such as software client 302 in FIG. 3, executes the flowchart shown in FIG. 8.

The process begins when the meeting begins and the software displays the agenda items and the tags to the chairperson (step 802). When the time arrives for an agenda item to be discussed, the chairperson selects the tag for that agenda item. The software determines which agenda item was selected (step 804). When the chairperson selects a tag for an agenda item, the software sends a notification message to each subscriber for that agenda item using the notification information provided by the subscriber (step 806). The software determines whether there are any more agenda items (step 808). If the answer is “yes” and there are more agenda items, the software waits for the chairperson to select an agenda item in step 804. If the answer is “no” and there are no more agenda items, then the process ends.

Thus, the different illustrative embodiments provide a computer implemented method, apparatus, and computer program product for subscribing to a set of items in an agenda. An agenda is created. The agenda comprises the set of items. A tag is associated with each item in the set of items to form a set of associated tags. A first user selects an associated tag from the set of associated tags, resulting in the first user subscribing to the item with the associated tag. Subscribing to the item means that the first user is sent an alert when an event related to the item occurs.

A chairperson creates an agenda with agenda items for a meeting. Each agenda item has an associated tag. The agenda is sent to one or more recipients. Each recipient determines which agenda items interest the recipient and then selects the tag associated with those agenda items to subscribe to those agenda items. The recipient specifies how the recipient is notified when the agenda item is the current topic of discussion during the meeting.

During the course of conducting the meeting with the agenda, the chairperson selects one agenda item after another. When an agenda item is selected during the meeting, it indicates that the agenda item is currently under discussion. When the chairperson selects an agenda item, each recipient who subscribed to that agenda item is notified using the information the recipient provided.

By using the technique described above, a meeting participant need not sit through a meeting when the participant is interested in only some of the agenda items in the meeting. The participant can subscribe to specific agenda items and then receive notification when those agenda items are being discussed during the meeting. Once the participant is notified, the participant can take appropriate action to participate in the meeting.

Meeting participants are more productive because the participants only attend those agenda items which interest the participants instead of having to attend the entire meeting. Meetings run smoothly because only those participants who are interested in an agenda item are participating in the discussion of that agenda item. Participants who are not interested in the agenda are not present and cannot slow down or disrupt the meeting because the participant does not understand the agenda item or because the participant is bored.

The flowchart and block diagrams in the figures illustrate the architecture, functionality, and operation of some possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for subscribing to a set of items in an agenda, the computer implemented method comprising:
creating an agenda, wherein the agenda includes the set of items;
associating a tag with each item in the set of items to form a set of associated tags; and
responsive to a first user selecting a tag from the set of associated tags, subscribing the first user to an item associated with the tag, wherein the first user receives an alert when an event occurs related to the item associated with the tag.

2. The computer implemented method of claim 1, wherein the agenda is in one of an electronic mail or a calendar event.

3. The computer implemented method of claim 1, further comprising:
responsive to a second user selecting the tag from the set of associated tags, sending the alert to the first user.

4. The computer implemented method of claim 3, wherein the step of sending the alert comprises one of sending an electronic mail to an electronic mail address, sending an instant message to an instant message identifier, sending an alphanumeric message to a pager, sending the alphanumeric message to a phone, or sending a pre-recorded voice message to the phone.

5. The computer implemented method of claim 3, wherein the second user is a chairperson of a meeting, and wherein the chairperson selects the tag to indicate that the item associated with the tag is under discussion in the meeting.

6. The computer implemented method of claim 1, further comprising:
sending a notification to a second user, wherein the second user is a chairperson of a meeting, and wherein the notification lists the set of items in the agenda and a number of subscribers who selected the tag associated with each item in the set of items in the agenda.

7. The computer implemented method of claim 1, further comprising:
responsive to the first user selecting the tag, unsubscribing the first user from the item associated with the tag, wherein unsubscribing the first user comprises not sending the alert to the first user when the event related to the item associated with the tag occurs.

8. The computer implemented method of claim 1, further comprising:
responsive to the item being placed in a second agenda, subscribing the first user to the item in the second agenda.

9. A computer program product comprising a computer usable medium including computer usable program code for subscribing to a set of items in an agenda, the computer program product comprising:
computer usable code for creating an agenda, wherein the agenda includes the set of items;
computer usable code for associating a tag with each item in the set of items to form a set of associated tags; and
responsive to a first user selecting a tag from the set of associated tags, computer usable code for subscribing the first user to an item associated with the tag, wherein the first user receives an alert when an event occurs related to the item associated with the tag.

10. The computer program product of claim 9, further comprising:
responsive to a second user selecting the tag from the set of associated tags, computer usable code for sending the alert to the first user.

11. The computer program product of claim 10, wherein the computer usable code for sending the alert comprises computer usable code for one of sending an electronic mail to an electronic mail address, sending an instant message to an instant message identifier, sending an alphanumeric message to a pager, sending the alphanumeric message to a phone, or sending a voice message to the phone.

12. The computer program product of claim 10, wherein the second user is a chairperson of a meeting, and wherein the chairperson uses computer usable code to select the tag, to indicate that the item associated with the tag is under discussion in a meeting.

13. The computer program product of claim 9, further comprising:
computer usable code for sending a notification to a second user, wherein the second user is a chairperson of a meeting, and wherein the notification lists the set of items in the agenda and a number of subscribers who selected the tag associated with each item in the set of items in the agenda.

14. The computer program product of claim 9, further comprising:
responsive to the first user selecting the tag, computer usable code for unsubscribing the first user from the item associated with the tag, wherein unsubscribing the first user comprises not sending the alert to the first user when the event related to the item associated with the tag occurs.

15. The computer program product of claim 9, further comprising:
responsive to the item being placed in a second agenda, computer usable code for subscribing the first user to the item in the second agenda.

16. A data processing system for subscribing to a set of items in an agenda, the data processing system comprising:
a bus;
a storage device connected to the bus, wherein the storage device contains computer usable code;
a communications unit connected to the bus; and
a processing unit connected to the bus for executing the computer usable code, wherein the processing unit receives an agenda, wherein the agenda comprises the set of items, wherein each item in the set of items is associated with a tag to form a set of associated tags, and responsive to a first user selecting a tag from the set of associated tags, subscribing the first user to the item associated with the tag, wherein the first user receives an alert when an event occurs related to the item associated with the tag.

17. The data processing system of claim 16 wherein the processing unit further executes the computer usable code and, responsive to a second user selecting the tag associated with the item, sends the alert to the first user.

18. The data processing system of claim 17, wherein the processing unit sends the alert by one of sending an electronic mail to an electronic mail address, sending an instant message to an instant message identifier, sending an alphanumeric message to a pager, sending the alphanumeric message to a phone, or sending a voice message to the phone.

19. The data processing system of claim 17, wherein the second user is a chairperson of a meeting, and wherein the chairperson selects the tag to indicate that the item associated with the tag is under discussion in a meeting.

20. The data processing system of claim 16, wherein the processing unit further executes the computer usable code and, responsive to the first user selecting the tag from the set of associated tags, unsubscribes the first user to the item with the associated tag, wherein the first user does not receive the alert when the event related to the item with the associated tag occurs.
